(19) United States
(12) Patent Application Publication
(10) Pub. No.: US 2007/0093638 A1
(43) Pub. Date: Apr. 26, 2007

(54) Method of preparation for imide-substituted polymer

(76) Inventors: Moon-kyoon Chun, Yeosu (KR); Chan-hong Lee, Daejeon (KR); Joong-jin Han, Seoul (KR); Tae-hoon Kim, Busan (KR)

Correspondence Address: CANTOR COLBURN, LLP, 55 GRIFFIN ROAD SOUTH, BLOOMFIELD, CT, 06002, US

(21) Appl. No.: 10/559,142

(22) PCT Filed: May 13, 2004
(86) PCT No.: PCT/KR04/01112

§ 371 Date: Dec. 1, 2005

(30) Foreign Application Priority Data
Jun. 11, 2003 (KR) 10-2003-0037512

(51) Int. Cl. C08G 69/08

(52) U.S. Cl. 528/310

(57) ABSTRACT

The present invention provides a method for manufacturing the imide-substituted polymer comprising the following four consecutive steps of (i) the copolymerization step of copolymerizing aromatic vinyl monomers and unsaturated dicarboxylic anhydride monomers, (ii) the separation step of removing the unreacted monomers and solvents from the abovementioned copolymerized solution continuously supplied to the separator, (iii) the imide substitution step of reacting unsaturated dicarboxylic anhydride units in said copolymers with primary amines, and (iv) the devolatilization step of removing low-molecular-weight volatiles from the polymer solution. The imide-substituted polymer manufactured according to the methods in the present invention has greatly improved the heat resistance and the productivity as the content of aromatic vinyl homopolymers is reduced significantly and the reaction time is shortened extensively.

### TECHNICAL FIELD

The present invention relates to an imide-substituted polymer which is excellent in heat resistance. The present invention also relates to a manufacturing method of the imide-substituted polymer.

### BACKGROUND ART

Generally, heat-resistant acrylonitrile-butadiene-styrene (ABS) resins having superior impact strength, processability, chemical resistance, gloss, etc. are applicable for various fields such as office automation devices, electric and electronic parts, home appliances, and automotive parts. It has been demanded gradually to produce higher heat-resistant resins.

Usually, styrene-acrylonitrile (SAN) resins that are used for the raw material of ABS resins are characterized by a good chemical resistance, mechanical properties, and transparency as well as excellent compatibility with SAN grafted rubber particles. Accordingly, SAN resins are used variously in many areas, but the poor heat resistance of them limits the use at a higher temperature. Therefore, the higher heat-resistant resins are required for the heat-resistant ABS resins.

There are many methods of endowing heat resistance to ABS resins. One of them is to increase heat resistance of raw material resins, and such resins are called heat-resistant resins. For example, heat-resistant resins are manufactured by the copolymerization of unsaturated dicarboxylic anhydrides and styrenes. Typically, maleic anhydride is used for an unsaturated dicarboxylic anhydride.

However, typical alternating copolymers manufactured according to the above-mentioned method are limited in their applications in spite of the high heat resistance since they have inferior weatherability and are susceptible to the thermal decomposition and the generation of gases at a high temperature.

In order to resolve the above-described problem, new methods introducing thermally stable cyclic imides in the copolymer backbone have been spotlighted. Direct copolymerization of styrenes and maleimides is easily applicable to produce a higher heat-resistant styrene-maleimide copolymer. But, more economical method to produce the styrene-maleimide copolymer is to introduce the primary amine and to substitute maleic anhydrides to maleimides in the main chain of styrene-maleic anhydride copolymers.

In Japanese Laid-Open Patent Publication No. S58-11514, copolymers having uniform compositional ratios were made by the variable feeding ratios of styrene and maleic anhydride according to the conversion. However, it is difficult to make the composition of copolymers uniformly and to obtain the polymerization conversion of greater than 90% and it lakes a long time for the production of the styrene-maleimide copolymer.

Disclosed in Japanese Laid-Open Patent Publication Nos. S58-1805, H2-4806, H6-56921, and H9-100322 is a continuous imide substitution method by the reactive extrusion in which the styrene-maleic anhydride copolymers are reacted continuously with amines in the molten state.

However, according to the abovementioned method, because the copolymer composition of raw materials is not uniform, the thermal stability of the final styrene-maleimide copolymers is not sufficient, and a discoloration is caused by unreacted amines due to the low yield of imide substitution reaction. Also, the intricate process may be necessary for the removal of unreacted amines since the amount of amines to be added is 2 to 3 times of the content of maleic anhydride units in copolymers, and thus, a large amount of unreacted amines remains and lowers various properties of the final resins.

Further, disclosed in Japanese Laid-Open Patent Publication No. 2001-329021 is a method for producing styrene-maleimide copolymers continuously. However, it takes longer than 10 hours for copolymerization of styrenes and maleic anhydrides and longer than 8 hours for the imide substitution, and therefore, the reaction efficiency becomes lower.

### DISCLOSURE

In order to resolve the above-described problems, a primary object of the present invention is to provide a method for manufacturing the imide-substituted polymer having an excellent heat resistance. In detail, the imide-substituted polymer, which is composed of 40˜55 wt % (weight percent) of aromatic vinyl units, 40˜60 wt % of maleimide units, and 0˜5 wt % of unsaturated dicarboxylic anhydride units, is produced by the imide substitution reaction with primary amines followed by the copolymerization of aromatic vinyl monomers and unsaturated dicarboxylic anhydride monomers.

Another object of the present invention is to maximize the heat resistance of imide-substituted polymer by increasing the imide content in said resins and minimizing the amount of aromatic vinyl homopolymers (particularly, polystyrene) that are formed during the production of said resins. Generally, the aromatic vinyl homopolymers greatly lower the heat resistance and various other physical properties.

Still another object of the present invention is to extensively shorten the reaction time of the copolymerization step and the imide substitution step in the manufacture of imide-substituted polymer.

In order to fulfill the above-described objects, the present invention provides a method for manufacturing the imide-substituted polymer comprising the following four consecutive steps of (i) the copolymerization step of copolymerizing aromatic vinyl monomers and unsaturated dicarboxylic anhydride monomers, (ii) the separation step of removing the unreacted monomers and solvents from the abovementioned copolymerized solution continuously supplied to the separator, ( iii) the imide substitution step of reacting unsaturated dicarboxylic anhydride units in said copolymers with primary amines, and (iv) the devolatilization step of removing low-molecular-weight volatiles from the polymer solution.

In more detail, the copolymerization step is done by dividing the feed into the Mixture (A) composed of aromatic vinyl monomers, initiators, and chain transfer agents and the Mixture (B) composed of unsaturated dicarboxylic anhydride monomers and solvents, and then charging copolymerization reactors simultaneously with them while adjusting the flow rate of each mixture according to the compositional ratio of the feed, and finally copolymerizing aromatic vinyl monomers and unsaturated dicarboxylic anhydride monomers in the copolymerization reactors. The separation step is performed by supplying the polymerization solution discharged from the copolymerization reactor into a separator continuously, and then removing unreacted monomers and solvents sufficiently. The imide substitution step is accomplished by supplying the polymer melt discharged from the separator continuously into imide substitution reactors and adding continuously the Mixture (C) composed of primary amines, catalysts for an imide substitution reaction, and solvents at the same time, and then reacting unsaturated dicarboxylic anhydride units in said copolymers with primary amines. Finally, the devolatilization step is done by removing low-molecular-weight volatiles (such as unreacted monomers, solvents, catalysts, etc.) from the polymer solution discharged from the imide substitution reactors into the devolatilizer. The final product is the imide-substituted polymer composed of 40˜55 wt % of aromatic vinyl units, 40˜60 wt % of rmaleimide units, and 0˜5 wt % of unsaturated dicarboxylic anhydride units.

The present invention will be described more precisely as follows:

<Step 1> Copolymerization Step of Aromatic Vinyl Monomers and Unsaturated Dicarboxylic Anhydride Monomers

The first step is the step of copolymerization of aromatic vinyl monomers and unsaturated dicarboxylic anhydride monomers in copolymerization reactors by dividing the feed into the Mixture (A) composed of aromatic vinyl monomers, initiators, and chain transfer agents and the Mixture (B) composed of unsaturated dicarboxylic anhydride monomers and solvents, and then charging the copolymerization reactors simultaneously with them while adjusting the flow rate of each mixture according to the compositional ratio of the feed. It is preferable to keep aromatic vinyl monomers and unsaturated dicarboxylic anhydride monomers in separate feed tanks since they may be polymerized even at a room temperature, and to have them mixed sufficiently before charging the copolymerization reactors. Therefore, it is preferable to divide them into the mixture composed of aromatic vinyl monomers, initiators, and chain transfer agents and the mixture composed of unsaturated dicarboxylic anhydride monomers and solvents.

Aromatic vinyl monomers used for the Mixture (A) include styrene monomers, such as styrene, a-methylstyrene, vinyltoluene, t-butylstyrene, chlorostyrene and substituted monomers thereof and mixtures thereof. Preferably, styrene, or a-methylstyrene, is used. It is desirable that the said aromatic vinyl monomers are 20 to 60 wt % of the tota amount of Mixtures (A) and (B), and more preferably, 30 to 50 wt %. If their content exceeds 60 wt %, the final resins have lower heat resistance.

For initiators used for the Mixture (A), organic peroxides having two or more functional groups may be used. Examples of such organic peroxides include 1,1-dibutyl-peroxy-3,3,5-trimethylcyclohexane, 1,1-dibutyl-peroxy-cyclohexane, 2,2-dibutyl-peroxy-butane, 2,2,4-trimethyl-pentyl-2-hydroperoxide, 2,5-dimethyl-2,5-di-(t-butyl-peroxy)hexane, 2,5-dimethyl-2,5-di-(benzoyl-peroxy)hexane, 1,1-di(t-amyl-peroxy)cyclohexane, 2,2-bis(4,4-di-t-butyl-peroxy-cyclohexyl)propane, ethyl-3,3-di(t-amyl-peroxy)butylate, ethyl-3,3-di(t-butyl-peroxy)butylate, 1,1-bis(t-butyl-peroxy)-3,3,5-trimethyl-cyclohexane and t-butyl-peroxy-3,3,5-trimethylhexanoate. It is preferable that the said initiators are 001 to 01 wt % of the total amount of the Mixtures (A) and (B). If their content is less than 001 wt %, the conversion of polymerization may be lowered and if it exceeds 01 wt %, the molecular weight is reduced greatly, thereby causing the final resins to have lower mechanical strength and it is difficult to control the reaction temperature.

As to chain transfer agents used for the Mixture (A), common chain transfer agents may be used. a-Methylstyrene dimer is preferably used in embodiments of the present invention shown below.

Unsaturated dicarboxylic anhydride monomers used for the Mixture (B) include maleic anhydride, methylmaleic anhydride, ethylmaleic anhydride, phenylmaleic anhydride, citraconic anhydride, and aconitic anhydride. It is preferable to use maleic anhydride. Preferably, the said unsaturated dicarboxylic anhydride monomers are 10 to 30 wt % of the toal amount of the Mixtures (A) and (B). If their content is 10 wt % or less, the final resins have lower heat resistance.

Solvents used for the Mixture (B) include ketones such as methyl ethyl ketone (MEK), cyclohexanone, methylisobutyl ketone (MIBK), and acetone, dimethyl formamide, or dimethyl sulfoxide. Methyl ethyl ketone and cyclohexanone, or their mixture is preferable. It is preferable that the said solvents are 20 to 60 wt % of the total amount of the Mixtures (A) and (B), more preferably 30 to 55 wt %. If their content is less than 20 wt %, the viscosity of the polymer solution becomes too high during the copolymerization step and it is difficult to control the reaction temperature, thereby causing problems in the whole polymerization processes. If it exceeds 60 wt %, the molecular weight of resins becomes decreased and the production efficiency is lowered greatly. The separation efficiency of solvents and unreacted monomers is, as well, lowered in the separator thereafter.

The Mixtures (A) and (B) are polymerized as charging one or more consecutive copolymerization reactors with them. The said copolymerization reactors include continuous-stirred tank reactors (CSTR), plug-flow reactors, and multi-stage reactors, and preferably, continuous-stirred tank reactors.

A reaction temperature in the copolymerization step ranges from 80 to 150° C., and more preferably 90 to 130° C. If the temperature is lower than 80° C., it may not be possible to secure a desired conversion and if it exceeds 150° C., it may not be possible to obtain the desired molecular weight and a relatively large amount of aromatic vinyl homopolymers, particularly polystyrene, may be generated.

It is desirable to have the conversion of the unsaturated dicarboxylic anhydride, particularly maleic anhydride, be 95 wt % or greater in the copolymerization step in view of the heat resistance and thermal stability.

And it is preferable to set the residence time in the copolymerization reactors to be the range of 2.5 to 5 hours, more preferably, the range of 3 to 4 hours. If the residence time is shorter than 2.5 hours, the heat resistance is lowered greatly due to the low conversion and if it exceeds 5 hours, the production of aromatic vinyl homopolymers (particularly, polystyrene) is increased greatly, and thus, the heat resistance and mechanical properties of the final resins are lowered.

<Step 2> Separation Step of Unreacted Monomers and Solvents

There exists a large amount of unreacted aromatic vinyl monomers in the copolymerized solution that has gone through the said copolymerization step, and a large amount of aromatic vinyl homopolymers (particularly, polystyrene) are formed according to the thermal initiation in the imide substitution reactors thereafter. Here, it is necessary to prevent the production of such homopolymers since they act as impurities lowering the heat resistance and mechanical properties in the imide-substituted polymer. A separation step is introduced after the copolymerization step to overcome the aforementioned problems, i.e., a step of separating unreacted monomers and solvents from the polymerized solution discharged from the copolymerization reactors and supplied to the separator continuously. A flash evaporator, falling-strand devolatilizer, thin-film evaporator, and vented extruder may be used as the said separator and a falling-strand devolatilizer is preferable.

When separating the unreacted monomers and solvents by using a falling-strand devolatilizer, the inside conditions of the separator is preferable at the temperature of 150 to 300° C. and the pressure of 20 to 200 torr, and more preferably at the temperature of 170 to 250° C. and the pressure of 30 to 150 torr. Further, it is preferable that the content of unreacted monomers and solvents removed from the above separator is larger than 90 wt % of the total amount of unreacted monomers and solvents contained in the polymerized solution discharged from the copolymerization reactors, and more preferably larger than 95 wt %.

<Step 3> Imide Substitution Step

The next step is a step of imide substitution reaction in which the polymer melt discharged from the separator and Mixture (C) composed of primary amines, catalysts for an imide substitution reaction, and solvents are supplied continuously into the imide substitution reactors in order to improve the heat resistance and thermal stability of resins. Here, the imide substitution reaction, or the imidization reaction, refers to a reaction of substituting the unsaturated dicarboxylic anhydride unit in aromatic vinyl-unsaturated dicarboxylic anhydride copolymer with the primary amine.

Primary amines used for the Mixture (C) include methylamine, ethylamine, propylamine, butylamine, hexylamine, cyclohexylamine, decylamine, aniline, toluidine, chlorophenylamine, and bromophenylamine. It is preferable to use aniline. The amount of the above primary amines charged differs according to the content of an unsaturated dicarboxylic anhydride monomers of the Mixture (B) since primary amines react with the unsaturated dicarboxylic anhydride units in the aromatic vinyl-unsaturated dicarboxylic anhydride copolymer at the mole ratio of 1:1. Preferably, the amount of the primary amines is ranged from 0.5 to 2.0 times in the mole ratio to the content of the unsaturated dicarboxylic anhydride units in the polymer melt supplied from the separator. If their amount is less than 0.5 times, the thermal stability and processability of the resins are lowered due to the unsubstituted unsaturated dicarboxylic anhydride units and if it exceeds 2.0 times, discoloration and lower physical properties may be caused as a large amount of primary amines remain in the resins.

Tertiary amines such as trimethylamine, triethylamine, and tributylamine may be used for the catalyst for the imide substitution reaction in the Mixture (C). It is preferable that the above catalyst is less than 10 wt % of the amount of prirmry amines in the Mixture (C). If their content exceeds 10 wt %, there is no effect for increasing the conversion of the imide substitution reaction and physical properties are decreased as they remain in the resins.

A Solvent in the Mixture (C) is the same kind of solvent in the Mixture (B) of the above copolymerization step. It is preferable that the above solvent is included at a ratio of 0.5 to 3.0 times of the amount of the solvent in the Mixture (B). If its content is less than 0.5 times, the conversion of imidization reaction may be lowered due to high viscosity. On the contrary, if it exceeds 3.0 times, the devolatilization step thereafter may be in trouble by too great a burden of the solvent.

The conversion of imide substitution may be maximized if the polymer melt discharged through the separator is mixed with the Mixture (C) uniformly immediately before the imide substitution reactors. The above imide substitution step is performed in one or more consecutive reactors, which are continuous-stirring tank reactors (CSTR), plug-flow reactors, or multi-stage reactors.

It is preferable that the above imide substitution reaction is performed at the temperature range of 120 to 200° C., more preferably, 130 to 180° C. If the reaction temperature is lower than 120° C., it may not be possible to obtain a desired conversion of the imide substitution, where the conversion of the imide substitution is shown in terms of the reaction conversion of the primary amine.

The conversion of the imide substitution in the above imide substitution step is greater than 70 mole %, preferably, 85 mole %, and more preferably, 90 mole %. If the said conversion is less than 70 mole %, the thernsl stability of the imide-substituted polymer is lowered greatly.

<Step 4> Devolatilization Step

Finally, the imide-substituted polymer is obtained after the devolatilization step in which low-molecular-weight volatile portions (such as unreacted monomers, solvents, catalysts, etc.) are removed sufficiently from the polymer solution discharged from the imide substitution step. The inside of the devolatilizer is maintained at the temperature of 200 to 350° C. and the pressure of 10 to 100 torr, and preferably, at the temperature of 230 to 320° C. and the pressure of 10 to 70 torr, respectively.

It is preferable that the final imide-substituted polymer manufactured by the said production method has less than 3 wt % of aronatic vinyl homopolymers. If it exceeds 3 wt %, the heat resistance of the resins is reduced and mechanical properties are lowered.

The said imide-substituted polymer is characterized by having a superior heat resistance as their glass transition temperature (T_{g}) is ranged from 175 to 195° C. Also, the heat resistance, weatherability, and mechanical properties of them are excellent since the conversion of the imide substitution of unsaturated dicarboxylic anhydrides units is greater than 95 wt %.

### BEST MODE

The Present invention will be discussed in further detail with reference to the following examples and comparative examples. However, it should be understood that the scope of the present invention is not limited by them.

### EXAMPLE 1

The first reactor (copolymerization reactor) having an inner volume of 42 L is simultaneously charged with the Mixture (A) (styrene/1,1-bis(t-butylperoxy)-3,3,5-trimethyl cyclohexane/a-methylstyrene dimer=38.5/0.03/0.05 in a weight ratio) and the Mixture (B) (maleic anhydride/mixed solvent=16.5/45.0 in a weight ratio) at the flow rates of 4.63 L/hr and 7.37 L/hr, respectively, and the copolymerization of the styrene and the maleic anhydride is performed at the temperature of 100° C., where the mixed solvent refers to a mixture of methyl ethyl ketone and cyclohexanone at a weight ratio of 30/70 which is applicable in the same way hereinafter. The polymerized solution from the first reactor is continuously put into a separator, and volatile portions (such as unreacted monomers and solvents) are removed while keeping the temperature of 230° C. and pressure of 80 torr, where the residence time in the separator is maintained to be within 30 minutes.

The imide substitution reaction is performed at 150° C. by charging the second reactor (imide substitution reactor) having an inner volume of 32 L with the polymerized solution discharged from the above separator and adding continuously the Mixture (C) (aniline/triethylamine/mixed solvent=25.6/0.8/73.6 in a weight ratio) at a flow speed of 7.33 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### COMPARATIVE EXAMPLE 1

The first reactor (copolymerization reactor) having an inner volume of 42 L is simultaneously charged with the Mixture (A) (styrene/1,1-bis(t-butylperoxy)-3,3,5-trimethyl cyclohexane/a-methylstyrene dimer=38.5/0.03/0.05 in a weight ratio) and the Mixture (B) (maleic anhydride/mixed solvent=16.5/45.0 in a weight ratio) at the flow rates of 4.63 L/hr and 7.37 L/hr, respectively, and the copolymerization of the styrene and the maleic anhydride is performed at the temperature of 100° C., where the mixed solvent refers to a mixture of methyl ethyl ketone and cyclohexanone at a weight ratio of 30/70.

The imide substitution reaction is performed at 153° C. by charging the second reactor (imide substitution reactor) having an inner volume of 32 L with the polymerized solution discharged from the first reactor and adding continuously the Mixture (C) (aniline/triethylamine=97.0/3.0 in a weight ratio) at a flow speed of 1.94 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### COMPARATIVE EXAMPLE 2

The first reactor (copolymerization reactor) having an inner volume of 42 L is simultaneously charged with the Mixture (A) (styrene/benzoyl peroxide/a-methylstyrene dimer=38.5/0.05/0.05 in a weight ratio) and the Mixture (B) (maleic anhydride/mixed solvent=16.5/45.0 in a weight ratio) at the flow rates of 4.63 L/hr and 7.37 L/hr, respectively, and the copolymerization of the styrene and the maleic anhydride is performed at the temperature of 85° C., where the mixed solvent refers to a mixture of methyl ethyl ketone and cyclohexanone at a weight ratio of 30/70.

The imide substitution reaction is performed at 140° C. by charging the second reactor (imide substitution reactor) having an inner volume of 32 L with the polymerized solution discharged from the first reactor and adding continuously the Mixture (C) (aniline/triethylamine=97.0/3.0 in a weight ratio) at a flow speed of 1.94 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### COMPARATIVE EXAMPLE 3

The first reactor (copolymerization reactor) having an inner volume of 42 L is simultaneously charged with the Mixture (A) (styrene/benzoyl peroxide/a-methylstyrene dimer=38.5/0.05/0.05 in a weight ratio) and the Mixture (B) (maleic anhydride/mixed solvent=16.5/45.0 in a weight ratio) at the flow rates of 2.32 L/hr and 3.68 L/hr, respectively, and the copolymerization of the styrene and the maleic anhydride is performed at the temperature of 85° C., where the mixed solvent refers to a mixture of methyl ethyl ketone and cyclohexanone at a weight ratio of 30/70.

The imide substitution reaction is performed at 140° C. by charging the second reactor (imide substitution reactor) having an inner volume of 32 L with the polymerized solution discharged from the first reactor and adding continuously the Mixture (C) (aniline/triethylamine=97.0/3.0 in a weight ratio) at a flow speed of 0.97 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### COMPARATIVE EXAMPLE 4

The first reactor (copolymerization reactor) having an inner volume of 42 L is simultaneously charged with the Mixture (A) (styrene/benzoyl peroxide/a-methylstyrene dimer=38.5/0.03/0.05 in a weight ratio) and the Mixture (B) (maleic anhydride/mixed solvent=16.5/45.0 in a weight ratio) at the flow rates of 4.63 L/hr and 7.37 L/hr, respectively, and the copolymerization of the styrene and the maleic anhydride is performed at the temperature of 100° C., where the mixed solvent refers to a mixture of methyl ethyl ketone and cyclohexanone at a weight ratio of 30/70. The polymerized solution from the first reactor is continuously put into a separator, and volatile portions (such as unreacted monomers and solvents) are removed while keeping the temperature of 230° C. and pressure of 80 torr, where the residence time in the separator is maintained to be within 30 minutes.

The imide substitution reaction is performed at 150° C. by charging the second reactor (imide substitution reactor) having an inner volume of 32 L with the polymerized solution discharged from the above separator and adding continuously the Mixture (C) (aniline/triethylamine/mixed solvent=25.6/0.8/73.6 in a weight ratio) at a flow speed of 7.33 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of fine imide-substituted polymer are measured.

### EXAMPLE 2

The first reactor (copolymerization reactor) having an inner volume of 42 L is simultaneously charged with the Mixture (A) (styrene/1,1-bis(t-butylperoxy)-3,3,5-trimethyl cyclohexane/a-methylstyrene dimer=41.2/0.03/0.05 in a weight ratio) and the Mixture (B) (maleic anhydride/mixed solvent=13.8/45.0 in a weight ratio) at the flow rates of 4.94 L/hr and 7.06 L/hr, respectively, and the copolymerization of the styrene and the maleic anhydride is performed at the temperature of 100° C., where the mixed solvent refers to a mixture of methyl ethyl ketone and cyclohexanone at a weight ratio of 30/70. The polymerized solution from the first rector is continuously put into a separator, and volatile portions (such as unreacted monomers and solvents) are removed while keeping the temperature of 230° C. and pressure of 80 torr, where the residence time in the separator is maintained to be within 30 minutes.

The imide substitution reaction is performed at 150° C. by charging the second reactor (imide substitution reactor) having an inner volume of 32 L with the polymerized solution discharged from the above separator and adding continuously the Mixture (C) (aniline/triethylamine/mixed solvent=22.4/0.7/76.9 in a weight ratio) at a flow speed of 7.02 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### EXAMPLE 3

The first reactor (copolymerization reactor) having an inner volume of 42 L is simultaneously charged with the Mixture (A) (styrene/1,1-bis(t-butylperoxy)-3,3,5-trimethyl cyclohexane/a-methylstyrene dimer=35.7/0.03/0.05 in a weight ratio) and the Mixture (B) (maleic anhydride/mixed solvent=19.3/45.0 in a weight ratio) at the flow rates of 4.28 L/hr and 7.72 L/hr, respectively, and the copolymerization of the styrene and the maleic anhydride is performed at the temperature of 100° C., where the mixed solvent refers to a mixture of methyl ethyl ketone and cyclohexanone at a weight ratio of 30/70. The polymerized solution from the first reactor is continuously put into a separator, and volatile portions (such as unreacted monomers and solvents) are removed while keeping the temperature of 230° C. and pressure of 80 torr, where the residence time in the separator is maintained to be within 30 minutes.

The imide substitution reaction is performed at 150° C. by charging the second reactor (imide substitution reactor) having an inner volume of 32 L with the polymerized solution discharged from the above separator and adding continuously the Mixture (C) (aniline/triethylamine/mixed solvent=28.7/0.9/70.4 in a weight ratio) at a flow speed of 7.67 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### EXAMPLE 4

The first reactor (copolymerization reactor) having an inner volume of 42 L is simultaneously charged with the Mixture (A) (styrene/1,1-bis(t-butylperoxy)-3,3,5-trimethyl cyclohexane/a-methylstyrene dimer=33.0/0.03/0.05 in a weight ratio) and the Mixture (B) (maleic anhydride/mixed solvent=22.0/45.0 in a weight ratio) at the flow rates of 3.96 L/hr and 8.04 L/hr, respectively, and the copolymerization of the styrene and the maleic anhydride is performed at the temperature of 100° C., where the mixed solvent refers to a mixture of methyl ethyl ketone and cyclohexanone at a weight ratio of 30/70. The polymerized solution from the first reactor is continuously put into a separator, and volatile portions (such as unreacted monomers and solvents) are removed while keeping the temperature of 230° C. and pressure of 80 torr, where the residence time in the separator is maintained to be within 30 minutes.

The imide substitution reaction is performed at 150° C. by charging the second reactor (imide substitution reactor) having an inner volume of 32 L with the polymerized solution discharged from the above separator and adding continuously the Mixture (C) (aniline/triethylamine/mixed solvent=31.4/1.0/67.6 in a weight ratio) at a flow speed of 8.0 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### EXAMPLE 5

The first reactor (copolymerization reactor) having an inner volume of 42 L is simultaneously charged with the Mixture (A) (styrene/1,1-bis(t-butylperoxy)-3,3,5-trimethyl cyclohexane/a-methylstyrene dimer=38.5/0.03/0.05 in a weight ratio) and the Mixture (B) (maleic anhydride/mixed solvent=16.5/45.0 in a weight ratio) at the flow rates of 4.63 L/hr and 7.37 L/hr, respectively, and the copolymerization of the styrene and the maleic anhydride is performed at the temperature of 120° C., where the mixed solvent refers to a mixture of methyl ethyl ketone and cyclohexanone at a weight ratio of 30/70. The polymerized solution from the first reactor is continuously put into a separator, and volatile portions (such as unreacted monomers and solvents) are removed while keeping the temperature of 230° C. and pressure of 80 torr, where the residence time in the separator is maintained to be within 30 minutes.

The imide substitution reaction is performed at 150° C. by charging the second reactor (imide substitution reactor) having an inner volume of 32 L with the polymerized solution discharged from the above separator and adding continuously the Mixture (C) (aniline/triethylamine/mixed solvent=25.6/0.8/73.6 in a weight ratio) at a flow speed of 7.33 L/hr. Finally, imide-substituted polymer is obtained by charging a devolatilizer with the product from the second reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the first and second reactors and various properties of final imide-substituted polymer are measured.

### EXAMPLE 6

The first reactor (first copolymerization reactor) having an inner volume of 26 L is simultaneously charged with the Mixture (A) (styrene/1,1-bis(t-butylperoxy)-3,3,5-trimethyl cyclohexane/a-methylstyrene dimer=38.5/0.03/0.05 in a weight ratio) and the Mixture (B) (maleic anhydride/mixed solvent=16.5/45.0 in a weight ratio) at the flow rates of 4.63 L/hr and 7.37 L/hr, respectively, and the copolymerization of the styrene and the maleic anhydride is performed at the temperature of 100° C., where the mixed solvent refers to a mixture of methyl ethyl ketone and cyclohexanone at a weight ratio of 30/70. The polymerized solution from the first reactor is further polymerized in the second reactor (second copolymerization rector) having an inner volume of 16 L at a temperature of 120° C., and then, the product of the copolymerization step is continuously put into a separator and volatile portions (such as unreacted monomers and solvents) are removed while keeping the temperature of 230° C. and pressure of 80 torr, where the residence time in the separator is maintained to be within 30 minutes.

The imide substitution reaction is performed at 150° C. by charging the third reactor (imide substitution reactor) having an inner volume of 32 L with the polymerized solution discharged from the above separator and adding continuously the Mixture (C) (aniline/triethylamine/mixed solvent=25.6/0.8/73.6 in a weight ratio) at a flow speed of 7.33 L/hr. Finally, imide-substituted polymer is obtained by charging a devolatilizer with the product from the third reactor at a temperature of 270° C. and a pressure of 20 torr and removing the volatile portions sufficiently during the residence time of within 30 minutes.

The polymerization conversion and imide substitution conversion of each monomer are measured by collecting the samples discharged from the second and third reactors and various properties of final imide-substituted polymer are measured.

Various properties of resins manufactured in the above examples 1 to 6 and comparative examples 1 to 4 are measured according to the following methods, and the results of measurements are shown in Tables 1 and 2 below:

a) Polymerization conversion and imide substitution conversion: In order to measure the polymerization conversion of styrene and maleic anhydride and the imide substitution conversion (conversion of aniline), the gas chromatography (GC) methods are used. Firstly, a fixed amount of polymerized sample is taken from the each reactor and dissolved in tetrahydrofuran (THF). The unreacted portions of the monomer components in the polymer solution are measured quantitatively by the use of GC method and conversions are calculated.

b) Copolymer composition: The composition of each of styrene, N-phenylmaleimide, and maleic anhydride in the final product is obtained according to the 13C-NMR method. A proper amount of samples is dissolved uniformly in the CDCl₃-d solvent and the composition is measured by using ARX300 of Bruker Company.

c) Molecular weight: The final resin of 0.2 g is dissolved in 20 mL tetrahydrofuran, the solution is filtered with a 0.45-mm filter, and its weight average molecular weight is obtained by using Gel Permeation Chromatography (GPC, Waters-Maxima 820), where the injection time is to be for 25 minutes and column temperature to be 40° C. for the measuring conditions.

d) Glass transition temperature: The glass transition temperature (T_{g}) of the final resin is measured by using Differential Scanning Calorimetry (DSC, Seiko Instruments-SSC5200), while increasing the temperature to 250° C. with the heating rate of 10° C./min after heating and cooling from 30 to 20° C. at a rate of 20° C./min once for the same thermal history.

e) Melt flow index (MFI): The final resin manufactured is extruded under the conditions of a temperature of 265° C. and a load of 10 kg according to the ASTM D-1238, and a melt flow index is measured by an amount of an extrusion for 10 minutes (g/10 min).

f) Content of polystyrene (content of aromatic vinyl homopolymer): The 100 g fine powder of the imide-substituted polymer is agitated in 1,000 g of ethylbenzene (EB) at a temperature of 70° C. for 24 hours so that the polystyrene which is soluble in EB is isolated fully from the imide-substituted polymer. The solid portion that is not dissolved in EB after 24 hours is filtered and, then, the above dissolution process is repeated once using that solid portion. EB is removed from the solution remained by using the vacuum distillation method, and the weight of the isolated resin, polystyrene, is measured in order to determine the content of the polystyrene in the resin.

TABLE 1

| | | | Comparative | Comparative | Comparative | Comparative |
|---|---|---|---|---|---|---|
| | | Example 1 | Example 1 | Example 2 | Example 3 | Example 4 |
| Polymerization | ST | 70.5 | 78.4 | 73.2 | 83.1 | 72.3 |
| conversion (wt %) | MAH | 97.2 | 96.8 | 84.3 | 97.3 | 91.4 |
| Imide substitution conversion (wt %) | | 93.5 | 87.3 | 75.9 | 91.8 | 88.7 |
| Reaction time | 1^{st} reactor | 3.5 | 3.5 | 3.5 | 7.0 | 3.5 |
| (hr) | 2^{nd} reactor | 2.7 | 2.3 | 2.3 | 4.6 | 2.7 |
| Composition | ST | 49.7 | 53.1 | 54.7 | 53.8 | 51.7 |
| of resin (wt %) | N-PMI | 49.3 | 44.3 | 42.2 | 44.7 | 47.4 |
| | MAH | 1.0 | 2.6 | 3.1 | 1.5 | 0.9 |

| | | | | | |
|---|---|---|---|---|---|
| Molecular weight (Mw) | 142,500 | 137,300 | 132,800 | 153,100 | 144,200 |
| Glass transition temperature (T_{g}, ° C.) | 183.2 | 172.6 | 165.4 | 173.1 | 177.8 |
| Melt flow index (g/10 min) | 5.5 | 17.8 | 25.2 | 15.3 | 7.3 |
| PS content (wt %) | 1.7 | 12.5 | 14.7 | 13.4 | 5.2 |

TABLE 2

| | | Example 2 | Example 3 | Example 4 | Example 5 | Example 6 |
|---|---|---|---|---|---|---|
| Polymerization | ST | 67.2 | 77.8 | 85.3 | 78.6 | 74.5 |
| conversion (wt %) | MAH | 98.1 | 96.3 | 95.8 | 98.9 | 99.2 |
| Imide substitution conversion (wt %) | | 94.2 | 92.5 | 92.9 | 95.3 | 97.2 |
| Reaction time | 1st reactor | 3.5 | 3.5 | 3.5 | 3.5 | 3.5 (1^{st} and 2^{nd}) |
| (hr) | 2nd reactor | 2.9 | 2.6 | 2.5 | 2.7 | 2.7 (3^{rd}) |
| Composition | ST | 54.5 | 46.8 | 44.1 | 51.9 | 49.8 |
| of resin (wt %) | N-PMI | 44.6 | 51.9 | 54.9 | 46.8 | 49.6 |
| | MAH | 0.9 | 1.3 | 1.0 | 1.3 | 0.6 |

| | | | | | |
|---|---|---|---|---|---|
| Molecular weight (Mw) | 141,700 | 145,600 | 150,400 | 140,700 | 142,200 |
| Glass transition temperature (T_{g}, ° C.) | 176.4 | 187.3 | 191.5 | 182.3 | 185.4 |
| Melt flow index (g/10 min) | 5.8 | 5.1 | 4.6 | 6.8 | 6.2 |
| PS content (wt %) | 2.1 | 1.6 | 1.3 | 2.9 | 2.4 |

From the above Tables 1 and 2, Example 1 is better in the heat resistance than Comparative Example 1 without the separation step because the content of the polystyrene in the final resin is increased greatly.

In Comparative Example 2, the temperatures of the copolymerization step and the imide substitution step are lowered in order to prevent the formation of the polystyrene. However, the heat resistance is lowered greatly as the conversion of maleic anhydride is decreased and the content of the polystyrene is not reduced. In Comparative Example 3 where the residence time is increased by decreasing the flow rates of the feed under the same reaction conditions as those of Comparative Example 2, the content of the polystyrene in the final resin is increased as the conversion of styrene is increased due to a long residence time even if the conversion of maleic anhydride is increased, thereby causing the lower heat resistance. It is, therefore, in examples of the present invention, confirmed that the products manufactured by the method given in the present invention have better physical properties compared to Comparative Example 3 even if the reaction time is shortened by more than twice.

In Comparative Example 4 that is performed under the same conditions as those of Example 1, the behavior of the copolymerization varies according to the type of initiators, and the amount of the polystyrene formed is increased as well. In Examples 2, 3, and 4, the behavior of the copolymerization and change in physical properties are observed while changing the content of styrene and maleic anhydride. And in Examples 5 and 6, which have the same compositional conditions of the feed as those of Example 1, the behavior of the copolymerization and change in physical properties according to the change in polymerization temperature in the copolymerization step are confirmed.

### INDUSTRIAL APPLICABILITY

As illustrated in the above, the present invention is useful to provide a manufacturing method of the imide-substituted polymer that has the excellent heat resistance by minimizing the additional formation of the aromatic vinyl homopolymers and the byproducts which is occurred between the unreacted unsaturated dicarboxylic anhydride and the primary amine during the imide substitution step. Furthermore, conversions of maleic anhydride and the imide substitution are greater than 90% and the productivity is improved remarkably by shortening the reaction times compared to those of the conventional methods.

It will be apparent to those skilled in the art that various modifications and variations can be made in the disclosed processes and products without departing from the scope or spirit, of the invention. Other embodiments of the invention will be apparent to those skilled in the art from consideration of the specification and practice of the invention disclosed herein. It is intended that the specification and examples be considered as exemplary only with a true scope and spirit of the invention being indicated by the following claims.

1. A method for manufacturing the imide-substituted polymer comprising the steps of:
copolymerization step done by dividing the feed into the Mixture (A) composed of aromatic vinyl monomers, initiators, and chain transfer agents and the Mixture (B) composed of unsaturated dicarboxylic anhydride monomers and solvents, and then charging copolymerization reactors simultaneously with them while adjusting the flow rate of each mixture according to the compositional ratio of the feed, and finally copolymerizing aromatic vinyl monomers and unsaturated dicarboxylic anhydride monomers in the copolymerization reactors;
separation step performed by supplying the polymerized solution discharged from the copolymerization reactors into a separator continuously, and then removing unreacted monomers and solvents sufficiently;
imide substitution step accomplished by supplying the polymer melt discharged from the separator continuously into imide substitution reactors and adding continuously the Mixture (C) composed of primary amines, catalysts for an imide substitution reaction, and solvents at the same time, and then reacting unsaturated dicarboxylic anhydride units in said copolymers with the primary amines; and
devolatilization step done by removing low-molecular-weight volatiles from the polymer solution discharged from the imide substitution reactors in the devolatilizer.

2. The method for manufacturing the imide-substituted polymer according to claim 1, wherein said aromatic vinyl monomer in the Mixture (A) is selected from the group consisting of styrene, α-methylstyrene, vinyl toluene, t-butylstyrene, chlorostyrene, substituted monomers thereof and mixtures thereof.

3. The method for manufacturing the imide-substituted polymer according to claim 1, wherein the amount of said aromatic vinyl monomer in the Mixture (A) is 20 to 60 wt % of the total amount of Mixtures (A) and (B) fed into said copolymerization reactors.

4. The method for manufacturing the imide-substituted polymer according to claim 1, wherein said initiator in the Mixture (A) is selected from the group of organic peroxides having two or more functional groups including 1,1-dibutyl-peroxy-3,3,5-trimethylcyclohexane, 1,1-dibutyl-peroxy-cyclohexane, 2,2-dibutyl-peroxy-butane, 2,2,4-trimethyl-pentyl-2-hydroperoxide, 2,5-dimethyl-2,5-di-(t-butyl-peroxy)hexane, 2,5-dimethyl-2,5-di-(benzoyl-peroxy)hexane, 1,1-di(t-amyl-peroxy)cyclohexane, 2,2-bis(4,4-di-t-butyl-peroxy-cyclohexyl)propane, ethyl-3,3-di(t-amyl-peroxy)butylate, ethyl-3,3-di(t-butyl-peroxy) butylate, 1,1-bis(t-butyl-peroxy)-3,3,5-trimethyl-cyclohexane, and t-butylperoxy-3,3,5-trimethylhexanoate.

5. The method for manufacturing the imide-substituted polymer according to claim 1, wherein the amount of said initiator in the Mixture (A) is 0.01 to 0.1 wt % of the total amount of Mixtures (A) and (B) fed into said copolymerization reactors.

6. The method for manufacturing the imide-substituted polymer according to claim 1, wherein said unsaturated dicarboxylic anhydride monomer in the Mixture (B) is selected from the group consisting of maleic anhydride, methylmaleic anhydride, ethylmaleic anhydride, phenylmaleic anhydride, citraconic anhydride, aconitic anhydride, and mixtures thereof.

7. The method for manufacturing the imide-substituted polymer according to claim 1, wherein the amount of said unsaturated dicarboxylic anhydride monomer in the Mixture (B) is 10 to 30 wt % of the total amount of Mixtures (A) and (B) fed into said copolymerization reactors.

8. The method for manufacturing the imide-substituted polymer according to claim 1, wherein said solvent in the Mixture (B) is selected from the group consisting of methyl ethyl ketone (MEK), cyclohexanone, methylisobutyl ketone (MIBK), acetone, dimethyl formamide, dimethyl sulfoxide, and mixtures thereof.

9. The method for manufacturing the imide-substituted polymer according to claim 1, wherein the amount of said solvent in the Mixture (B) is 20 to 60 wt % of the total amount of Mixtures (A) and (B) fed into said copolymerization reactors.

10. The method for manufacturing the imide-substituted polymer according to claim 1, wherein a temperature of polymerization in said copolymerization step is ranged from 80 to 150° C.

11. The method for manufacturing the imide-substituted polymer according to claim 1, wherein said copolymerization reactors in said copolymerization step have one or more reactors consecutively and the temperature of each reactor is increased gradually within the range of 80 to 150° C.

12. The method for manufacturing the imide-substituted polymer according to claim 1, wherein the inside of said separator in said separation step has a temperature condition within the range of 150 to 300° C. and a pressure condition within the range of 20 to 200 torr.

13. The method for manufacturing the imide-substituted polymer according to claim 1, wherein said primary amine in the Mixture (C) is selected from the group consisting of methylamine, ethylamine, propylamine, butylamine, hexylamine, cyclohexylamine, decylamine, aniline, toluidine, chlorophenylamine, bromophenylamine, and mixtures thereof.

14. The method for manufacturing the imide-substituted polymer according to claim 1, wherein the content of said primary amine in the Mixture (C) is ranged from 0.5 to 2.0 times in the mole ratio to the content of the unsaturated dicarboxylic anhydride units in the polymer melt supplied from the separation step.

15. The method for manufacturing the imide-substituted polymer according to claim 1, wherein said catalyst for an imide substitution reaction in the Mixture (C) is selected from the group consisting of trimethylamine, triethylamine, tributylamine, and mixtures thereof.

16. The method for manufacturing the imide-substituted polymer according to claim 1, wherein the amount of said catalyst in the Mixture (C) is less than 10 wt % of the amount of the primary amine in the Mixture (C).

17. The method for manufacturing the imide-substituted polymer according to claim 1, wherein the amount of said solvent in the Mixture (C) is 0.5 to 3.0 times of the amount of said solvent in the Mixture (B).

18. The method for manufacturing the imide-substituted polymer according to claim 1, wherein the reaction temperature of said imide substitution step is ranged from 120 to 200° C.

19. The method for manufacturing the imide-substituted polymer according to claim 1, wherein the inside of said devolatilizer in said devolatilization step has a temperature condition within the range of 200 to 350° C. and a pressure condition within the range of 10 to 100 torr.

20. The method for manufacturing the imide-substituted polymer according to claim 1, wherein the conversion of said unsaturated dicarboxylic anhydride in said copolymerization step is greater than 95 wt %.

21. The method for manufacturing the imide-substituted polymer according to claim 1, wherein the residence time in said copolymerization step is within the range of 2.0 to 5.0 hours and the residence time in said imide substitution step is within the range of 1.5 to 4.0 hours.

22. The method for manufacturing the imide-substituted polymer according to claim 1, wherein the content of aromatic vinyl homopolymers contained in said imide-substituted polymer manufactured through said devolatilization step is less than 3 wt %.

23. An imide-substituted polymer manufactured according to claim 1.
